(19) United States
(12) Patent Application Publication
(10) Pub. No.: US 2023/0361714 A1
(43) Pub. Date: Nov. 9, 2023

(54) CONSTRUCTION METHOD AND SYSTEM OF A SOLAR CELL POWER PLANT

(71) Applicants: Jong Hae KIM, Gimpo-si Gyeonggi-do (KR); Michael J. KIM, Reseda, CA (US); Tommy Y. KIM, Verdes Palos Rancho (UA)

(72) Inventors: Jong Hae KIM, Gimpo-si Gyeonggi-do (KR); Michael J. KIM, Reseda, CA (US); Tommy Y. KIM, Verdes Palos Rancho (UA)

(21) Appl. No.: 18/134,939

(22) Filed: Apr. 14, 2023

Related U.S. Application Data
(63) Continuation-in-part of application No. PCT/KR2021/007009, filed on Jun. 4, 2021.

(30) Foreign Application Priority Data
Oct. 14, 2020 (KR) 10-2020-0132555

(51) Int. Cl. H02S 20/10; E02D 7/00; E02B 17/00; E02D 27/42; H02S 10/12; H02S 40/20

(52) U.S. Cl. CPC H02S 20/10; E02D 7/00; E02B 17/00; E02D 27/425; H02S 10/12; H02S 40/20; E02B 2017/0043; E02B 2017/0091

(57) ABSTRACT

A method for constructing a solar cell farm includes steps of: (1) installing a plurality of reinforced concrete piles on a latticed divided surface of a ground or a water level of the foreshore in a solar cell panel installation area; (2) constructing a lattice-type truss by connecting a plurality of steel beams in a transverse direction on the concrete piles and a plurality of rails on the steel beams in a longitudinal direction on the steel beams; (3) installing a solar cell panel by varying the slope of the panel by varying the length of a length-variable connection means between the plurality of rails of the truss and 4 axes of the left, right, upper and lower sides of the solar cell panel; and (4) constructing a rail for driving the track vehicle between the rails mounted on the transverse steel beams of the truss.

### CROSS-REFERENCE TO RELATED APPLICATIONS

This application is a continuation-in-part of PCT International Application No. PCT/KR2021/007009 filed on Jun. 4, 2021, which claims priority to Korean Patent Application No. 10-2020-0132555 filed on Oct. 14, 2020, which are incorporated herein by reference in their entireties.

### TECHNICAL FIELD

The present invention is an improved patent of Korean Patent Registration No. 10-2009941, which was filed by the applicant on Jun. 21, 2017, and PCT/KR2018/007699 filed by the applicant.

The present invention concerns a method and system apparatus for constructing a solar cell power plant using tidal flats on a beach, wasteland or farmland without compromising the use of the land; more specifically, the present invention provides a structure that is safe from typhoons without tilting due to load distribution by fixing and driving concrete piles in a lattice shape at a height of at least 1 m from the water surface of tidal flats, wasteland or farmland without transforming the abandoned tidal flats, wasteland or farmland, and then, on top of the concrete piles, by forming a lattice-type truss structure that connects a transverse steel structure and a plurality of longitudinal rails; the present invention improves the solar collection efficiency by forming a solar cell panel that changes the panel's inclination in the direction of 360 degrees by connecting the rails and the 4 axes of the upper, lower, left and right sides of the solar cell panel with a length-variable connecting means between the rails of the structure; the present invention improves the lifespan of the solar power plant semi-permanently because it is easy to install, dismount, or do after-installation maintenance or replacement for each panel using rails; the present invention provides an optimal solution to build an eco-friendly hybrid power generation system that substitutes nuclear or thermal power generation by additionally configuring wind power generation means that share access paths, transmission routes and ESS.

### BACKGROUND

The existing method of installing solar cell panels is to install a panel composed of a plurality of solar cell modules on a cradle on the ground and to adjust the inclination of the panel in advance or remotely control it; such a method is vulnerable to typhoons or strong winds due to the weight and height of the solar cell panel, and a large area of land is required as a separation distance is necessary to avoid shade between the panels.

In Korean Patent Registration No. 10-1108713 (Solar Power Generation Apparatus with Easiness of Adjusting Inclination Angles), an apparatus that connects the cradle and the solar cell panel with a hinge axis and varies the inclination on the hinge axis is configured, but there is a problem whereby the panel is knocked down by strong wind due to the high load of the solar cell panel itself, thereby damaging the panel.

Korean Patent Registration No. 10-1670346 (Solar Power Generation Apparatus for Installing on Standing-Seam Roofs) discloses a configuration in which an upper frame supporting the solar cell panel and a lower frame supporting the frame are configured as prefabricated and the installation is completed by fixing the inclination of the panel; however, this method has a problem that the inclination cannot be arbitrarily adjusted after installation.

Korean Patent Registration No. 10-0887723 (Offshore Fixed Structure for Solar Power Collection Panels) has been registered for a patent for an offshore structure for installing solar power collection panels in rivers or lakes; however, there is a problem that the unit cost of power generation is at least twice that of conventional thermal power generation because the installation cost is still high.

Existing solar power generation systems installed on lakes or shores are all floating-type offshore power generation systems, and there is a problem the cost of building offshore wind power generation facilities is high.

In the case of Korea, for instance, the tidal flat area is 2,482 km² (Korean government 2019 data), and 1 ha of land is required for 1 MW of solar power generation; hence, if solar power generation facilities are built by using abandoned tidal flats in Korea, 248,200 MW of electricity can be generated. This means that it can replace 248 nuclear power plants or thermal power plants with a capacity of 1,400 MW.

In 1954, Bell Laboratories recorded an efficiency of 4% with a silicon (Si) solar cell; yet, by enhancing the purity of the material and improving the manufacturing process technology, now the efficiency of mass-produced cells has been improved to around 15%. Then, it became possible to increase the mass production efficiency by 22% or more and reduce the manufacturing cost of a solar cell to ⅓ or less with the metal oxide called perovskites.

As such, the cost could be reduced as above and the Grid Parity—where the cost of photovoltaic power generation required to produce 1 KW of electricity equals the cost of producing general electricity produced using fossil fuels—has already been reached; however, since it is difficult to secure large-scale land, there are difficulties in constructing large-scale solar power plants.

Even more so, since countries worldwide are declaring carbon-neutral targets by 2050, it is critical to developing technology to build large-scale photovoltaic power generation facilities on top of tidal flats, wastelands or farmlands, which have been neglected to reduce carbon emissions, without harming such lands' functions.

In countries worldwide, nuclear fission-type nuclear power generation is vulnerable to earthquakes or tsunamis; also, if a nuclear power plant is destroyed by bombing during wartime, it causes damage on the scale of an atomic bomb, so nuclear power plants are not established at the outset in Israel; countries with a risk of war or terrorism increasingly tend to avoid nuclear power plants.

Moreover, in the case of thermal power generation using coal, various countries are closing down such power generation facilities due to pollution; hence, it is necessary to develop an industrial solar power generation technology that can replace nuclear power or thermal power generation in the future and an eco-friendly power generation system that can dramatically lower the costs of power generation.

In the present invention, a solar cell panel collectively refers to the photovoltaic power generation array that actually generates electricity by combining modules, which are the smallest units of solar cells or photovoltaic cells; including the frame for protecting arrays, it is referred to as solar power panel or a solar cell panel.

### BRIEF DESCRIPTION OF THE DRAWINGS

FIG. 1 is a plan view of the system configuration of the present invention.

FIG. 2 is a 3D perspective view of the system configuration of the present invention.

FIG. 3 is a configuration diagram of the system apparatus that converts the inclination of each panel of the present invention.

10; Horizontal cradle
11; Rail for mounting solar cell panels
12; Rail for operating trackwork vehicles
13; Solar cell panels
14; Means of connection
15; Concrete pile support posts

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention provides specific methods and system technology that do not affect the existing fisheries business of fishermen because reclamation is expensive and there are concerns about damage to fishermen in order to build a solar power generation system on the coastal tidal flat, do not damage tidal flats, and can build solar cell panels at a height of 1 m or more, preferably 3 m or more, from the sea level at high tide.

In order for a large-scale solar cell panel to be built on a tidal flat, it must have a structure that can withstand sea winds and typhoons without sinking or collapsing; and it is necessary to develop a solar power generation panel installation system that can arbitrarily change the panel's inclination even after its installation and can change the inclination of the panel in 360-degree direction to maximize the solar collection efficiency.

In addition, in the case of wasteland, concrete piles are built in a lattice shape with a height of 1 meter or higher based on the highest point of the wasteland curve without large-scale civil engineering work to make various curved surfaces of the desolate desert-type wasteland flat into a flat land; a lattice-type truss is established with multiple longitudinal rails on the cradle and pedestal on the concrete piles in order to provide a structure that is safe even against typhoons; a solution is provided to compensate for the decrease in power generation efficiency of solar cells due to geothermal heat in desert-type wastelands.

Also, in the case of farmland, concrete piles are placed in a lattice shape at least 3 meters above the farmland, and a lattice-type truss is built on top of which a horizontal steel frame cradle and a plurality of longitudinal rails are connected to provide agricultural solar power generation system that does not harm farming by adjusting the distance between solar cell panels among the rails.

Hence, the present invention is a hybrid power generation system that mutually complements the shortcomings of solar power generation and wind power generation by building a large-scale solar cell panel on tidal flats, wasteland or farmland and by additionally constructing a plurality of wind power generation facilities that share an access path, transmission route and ESS; the purpose of the present invention is to provide a method of constructing a large-scale eco-friendly power plant and system technology that can replace thermal power or nuclear power generation.

In order to achieve the above purpose, the present invention provides a truss structure that is safe against typhoons by driving piles made of non-corrosive material in tidal flats, wasteland or farmland into the ground in a lattice pattern, constructing a transverse iron support on the piles, and constructing a lattice-type truss that connects a number of longitudinal rails and distributing the load on the transverse iron support.

By constructing the height of the truss to be at least 1 m, preferably 3 m or more, from the sea level of the tidal flat or the surface of the farmland, and constructing it to be at least 1 m from the high point of the curved surface in the case of wasteland, the present invention provides a system that does not damage tidal flat fishing, farming or wasteland ecosystems.

The present invention is safe even against typhoons by connecting the 4 axes of the solar cell panel between the rails with variable length connecting means per axis and provides a structure that enhances the solar light collection efficiency by varying the inclination of the panel in the direction of 360 degrees based on the variance of the length of each connecting means.

The structure on which the solar cell panels are installed consists of rails to provide a structure that is safe against strong winds, and the gap between the panels is arbitrarily variable between the rails to provide a structure that enables concurrent engagement in fishing or farming.

In between the rails, rails are used to transport heavy solar cell panels to railcars equipped with cranes; because the cranes make it easy to install, dismount, replace and troubleshoot solar panels, the lifespan of the system is improved semi-permanently.

Moreover, effective solar power generation facilities are built on vast tidal flats, wasteland or farmland; in addition, by additionally building multiple wind power generation facilities, the present invention provides technology for building a hybrid power generation station that mutually complements solar power generation and wind power generation by sharing the access paths, transmission routes and ESS.

### Effect of the Invention

Existing solar cell panels had a problem of increasing the cost of power generation due to high land prices when installed on flat land, and there were difficulties of not being able to build large-scale solar power generation facilities in cities due to residents' resistance against panel reflected light waves.

Due to the above problems, in some countries, experiments are continuing with building photovoltaic power generation facilities on the bottom of a salt field or on a road surface, but the problem of high cost exists.

In order to solve the above problems and reduce the cost of solar power generation, the present invention provides an economical way and system apparatus to build a large-scale solar cell panel power plant on abandoned tidal flats on a beach, wastelands or farmland without harming the unique functions of tidal flats, wastelands or farmland.

The present invention, by configuring a lattice-type truss structure with a transverse iron cradle and a plurality of longitudinal rails at the top of a plurality of concrete piles placed on a lattice-type pattern on tidal flats, wasteland or farmland, provides a structure that does not sink by distributing the load, is not titled, is sturdy, and is safe even against typhoons.

In addition, the present invention, by using a rail to combine the role of longitudinal support and a panel cradle, has the effect of greatly reducing system construction costs because there is no need to configure a separate panel cradle.

Furthermore, because the solar cell panels are installed and dismounted using rails, it is easy to install and dismantle the solar panels; also, as it is easy to repair or replace each panel in case of failure, the present invention has the effect of improving the lifespan of the solar power plant semi-permanently.

In addition, the present invention is a hybrid power plant configuration in which the power generation is mutually supplemented even at night or when there is no wind by building wind power generation facilities in addition to photovoltaic power generation facilities on tidal flats, wasteland or farmland to share access paths, transmission routes and ESS, and it thus provides eco-friendly power plant construction technology that replaces nuclear power generation and thermal power generation.

Also, because the present invention builds solar cell panels on rails using rails, it has the effect of providing a win-win system whereby the sunlight irradiation rate is increased and thereby obstacles to tidal flat fishing and farming are minimized by adjusting the space between rails or with the reflectors attached to the back of the panel.

In particular, the present invention not only does not interfere with the livelihood of fishermen using tidal flats but also provides a means to swiftly move at high tide using a railcar built between the rails of this system, thereby providing a win-win system.

### BEST MODE FOR IMPLEMENTING THE PRESENT INVENTION

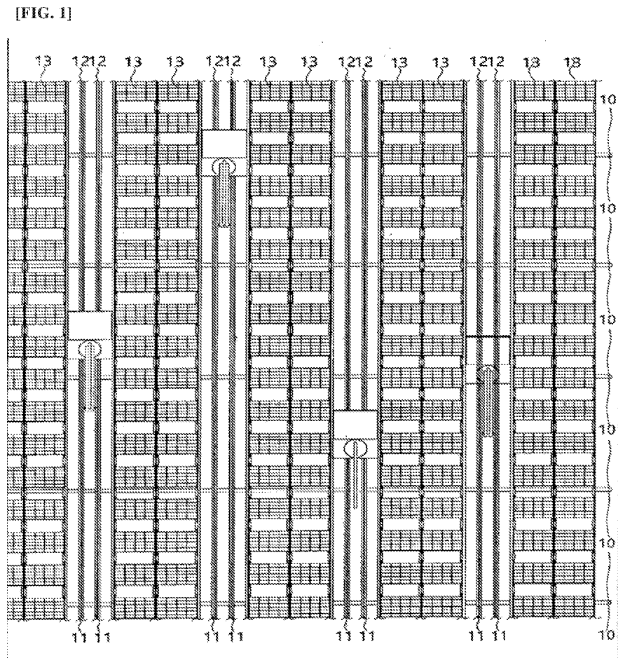

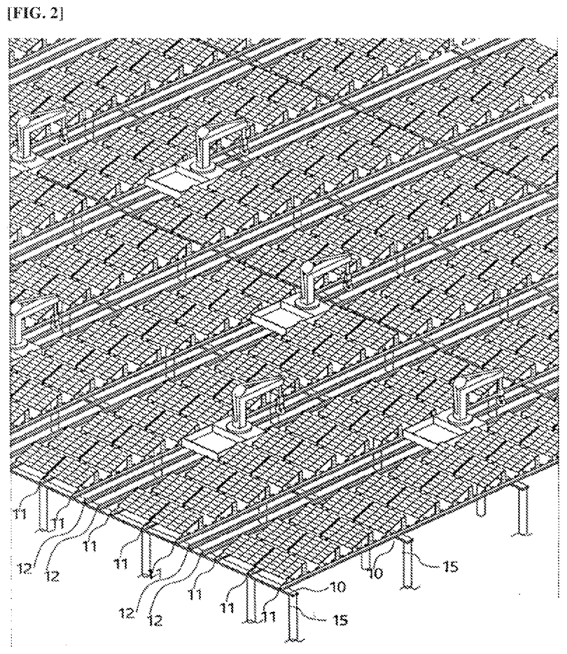

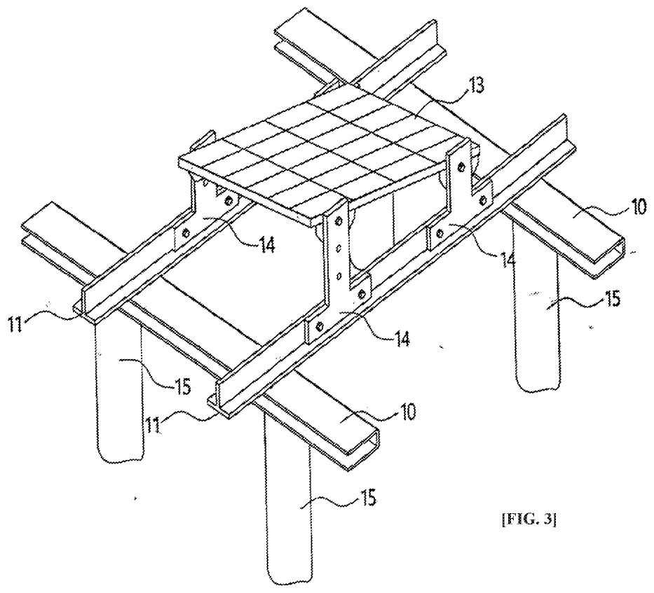

As shown in FIGS. 1, 2 and 3, the power generation system of the present invention is the configuration that includes a plurality of support posts (15) made of concrete piles that are driven in to a tidal flat, wasteland or farmland in a lattice shape with a pile-hammer and fixed at a height of 1 m or more from the sea level or from the surface of the wasteland or farmland, preferably 3 m or more thereof, a transverse cradle (10) composed of a plurality of steel frame structures bonded on the plurality of concrete support posts built in the lattice shape as above, a lattice-type truss (FIG. 2) constructed with a transverse support and a longitudinal rail by joining a plurality of rails (13) on the longitudinal direction on the transverse support, a solar cell panel (13) that is configured to adjust the panel's direction in the direction of 360 degrees by connecting the left, right, top and bottom 4 axes of the solar cell panel to the rail between the plurality of rails bonded to and configured on the above truss with length-variable connecting means (14), and a rail (12) built for operation of a working rail car between the rails on which the solar cell panel above is mounted; the present invention provides a structure in which the entire solar cell mounting system does not tilt or sink due to the soil adhesion of the concrete piles driven into and fixed on the ground and the lattice-type truss structure; based on the variable setting of the inclination of the solar cell panel in a 360-degree direction, the present invention enhances the efficiency of solar collection; based on the track car equipped with a crane for working along the rail, it is easy to transport, install, dismount and maintain the solar panels, so the present invention consists of a system apparatus that improves the lifespan of a solar power generation station semi-permanently.

### Mode for Implementing the Invention

As shown in FIGS. 1, 2 and 3, the power generation system of the present invention is the configuration that includes a plurality of support posts (15) made of concrete piles that are driven in to a tidal flat, wasteland or farmland in a lattice shape with a pile-hammer and fixed at a height of 1 m or more from the sea level or from the surface of the wasteland or farmland, preferably 3 m or more thereof, a transverse cradle (10) composed of a plurality of steel frame structures bonded on the plurality of concrete support posts built in the lattice shape as above, a lattice-type truss (FIG. 2) constructed with a transverse support and a longitudinal rail by joining a plurality of rails (13) on the longitudinal direction on the transverse support, a solar cell panel (13) that is configured to adjust the panel's direction in the direction of 360 degrees by connecting the left, right, top and bottom 4 axes of the solar cell panel to the rail between the plurality of rails bonded to and configured on the above truss with length-variable connecting means (14), and a rail (12) built for operation of a working rail car between the rails on which the solar cell panel above is mounted; the present invention provides a structure in which the entire solar cell mounting system does not tilt or sink due to the soil adhesion of the concrete piles driven into and fixed on the ground and the lattice-type truss structure; based on the variable setting of the inclination of the solar cell panel in a 360-degree direction, the present invention enhances the efficiency of solar collection; based on the track car equipped with a crane for working along the rail, it is easy to transport, install, dismount and maintain the solar panels, so the present invention consists of a system apparatus that improves the lifespan of a solar power generation station semi-permanently.

In the above configuration, by configuring the variable-length connecting means to be hydraulic or electric, it can be configured so that the inclination of each panel can be remotely adjusted from the control center when additionally configuring the ID and electronic control apparatus.

In addition, by configuring each length-variable connecting means and the rail joint to be fixed with two or more bolt nuts, the present invention provides a stable structure that does not tilt even in strong winds or typhoons.

Moreover, the system of the present invention is built on a vast area of tidal flats and because the area of one tidal flat is at least 10 km² (1,000 ha) on average and thus it is impossible to install or maintain on foot, it is desirable to construct a lightweight electric rail car track in conjunction with the rail; if necessary, however, it can be replaced with a steel pipe or a perforated steel plate using light vehicles using oil or gas.

Moreover, in the case of the concrete piles (posts) that are riven into the tidal flat, their soil adhesion increases as they are driven deeper into the ground; to note, it is preferable to drive the posts into and fix them between 10 and 20 meters underground and, if the tidal flat or wetland is deep, the posts can be fixed by connecting concrete piles or high-strength PHC concrete posts and driving them into the underground bedrock layer or 50 meters or more.

For the method of fixing the posts consisting of concrete piles by driving them into tidal flats, wasteland or farmland, pile-hammers such as PILE-HAMMAR or PILE-DRIVER are used; since the issue of the height of the posts to be driven into the ground with the pile-hammer from the sea level, wasteland or farmland surface at high tide is determined by the nature of the land or the crops of the farmland, so the height of the post is not limited in the present invention.

In the present invention, the ground height of the concrete piles to be built by driving the piles into the tidal flats or farmland is preferably 3-4 meters in order not to interfere with fishing or farming, and in the case of wasteland, a height of at least 1 meter is desirable so as not to damage the ecosystem by leaving the bend of the wasteland intact; however, the specific height should be determined to be suitable for the local site by examining the form and characteristics of the site.

In the case of the truss to be built on wasteland, farmland or tidal flat, the system of the present invention can be constructed by dividing the area of the truss into a plurality as necessary.

In the present invention, by configuring a plurality of high-strength PHC piles or concrete piles that are not easily corroded by seawater in a lattice shape at a depth of 10-20 meters below the tidal flat, and a steel lattice truss is fixed on the top thereof, the configuration prevents the truss from tilting or sinking based on the lateral adhesion and frictional force of the soil and the structural control of the steel truss bound to the top, in addition to preventing partial sinking of the concrete support posts because the gravity applied to the truss is evenly distributed, thereby providing a safe structure even when building heavy equipment on the trust.

The above theory is the same as the theory that the world's tallest building built on sand in the UAE does not collapse, and the above theory is confirmed by the fact that the Leaning Tower of Pisa in Italy became a leaning tower because there is no pile configured underground.

In the present invention, the horizontal cradle mounted on the concrete post (pile) consists of a plurality of rails and a steel structure or reinforced concrete beams designed to support the weight of solar cell panels; the rails for mounting solar cell panels can be configured by selecting from T-beams, L-beams, H-beams, □-beams, and ∪-beams, or by connecting two or more of the said rails.

In addition, in the present invention, the reason behind configuring the piles to be driven into and fixed on the ground as concrete piles is due to the concrete pile support post's characteristic of not being corroded by the salt of seawater; the pile can be configured by waterproofing high-strength PHC pile, steel pile, mono pile, or hardwood; the concrete blocks can be buried underground to fix the piles according to the condition of the stratum in wasteland or farmland.

In addition, when it is intended to build a super-scale wind power generation facility in a tidal flat or wetland, the present invention can be configured with a mono pile instead of a concrete pile.

The method of constructing the system of the present invention is first not affected by high tide and low tide; even in the case of constructing the solar power generation facility of the present invention on a soft tidal flat, it neither tilts nor sinks, and a structural configuration that is safe from typhoons is essential.

To achieve the above goal, the method of constructing the solar cell power plant of the present invention consists of the following steps: the step of placing a plurality of concrete posts (15) in a lattice pattern on the area where the solar cell panel is to be installed in tidal flats, wasteland or farmland, thereby driving and fixing a pile (post) with a pile-hammer at a height of at least 1 m or more from the sea level of the tidal flat or the surface of the farmland; the step of constructing by bonding a horizontal cradle (10) made of a steel frame structure or a reinforced concrete structure on the plurality of concrete support posts; the step of constructing a lattice-type truss consisting of a horizontal support and a vertical rail by connecting a plurality of rails in the longitudinal direction on the horizontal support (FIGS. 1 and 2); the step of using the length-variable connecting means (14) to connect the plurality of rails bonded to the lattice-type truss and the four axes of the upper, lower, left, and right sides of the solar cell panel, and then constructing a solar cell panel by varying the solar cell panel's inclination in a direction of 360 degrees by varying the length of the connecting means; and the step of building the rail (12) on a horizontal cradle for operating a working rail car between the rails on which the solar cell panel is mounted. By doing so, the present invention achieves the goal of semi-permanently improving the lifespan of a solar power generation station because the entire solar cell mounting system neither tilts nor sinks thanks to the lattice-type truss structure connected on a plurality of lattice-type concrete piles, the efficiency of solar collection is improved by setting the inclination of each solar cell panel in a 360-degree direction, and the transportation, installation, dismounting and maintenance of the panels are easy by utilizing a track vehicle equipped with a crane that operates along the rail.

In the above configuration, the installation and dismantling of the panels can be simplified and eased by the additional configuration that is connecting the upper and lower parts of the multiple solar cell panel frames, pulling them between the rails with electric wrenches and attaching them to the rails or pulling them down in order to dismantle them.

Moreover, by configuring stairs to access tidal flats, farmland or wastelands per specific section where the railcar travels provides a useful means for quick access by railcar.

The electric cable that connects the solar cell panels of the present invention is installed by configuring a mounting means on top of the plurality of concrete pile support posts (15) in order to solve the obstacle caused by the weight of the cable.

Additionally, by additionally configuring the fishing net mounting means on the support posts (15) along the coastline of the tidal flat, the configuration can be used as a fishing means that utilizes low tide and high tide.

Also, it is possible to support the livelihood of tidal flat fishermen by configuring at the bottom of the horizontal cradle on the tidal flat so that small fishing boats can pass through.

Moreover, land use efficiency can be improved by building a greenhouse, greenhouse, warehouse, factory or barn under the lattice-type truss built in farmland; in necessary cases, if a lattice-type truss is built at a height of 5 m or more above the ground with concrete piles or steel frame piles built in the wasteland, a warehouse, factory, vinyl house, barn or facility supporting the system of the present invention can be built and utilized under the truss.

In addition, a reflector can be configured on the back of the panel to reinforce the function of tidal flats or farmland with reflected light between the panels, and the reflector on the back of the panel can be made of a film that has a separate solar cell power generation function.

In the above configuration, the rail vehicle can be configured as a lightweight work vehicle that uses oil or gas instead of the electric rail vehicle; it can be substituted and configured with a perforated lightweight steel plate structure or wooden structure instead of the rail.

In the present invention, a remote control means for adjusting the inclination angle of the panel can be additionally configured by connecting two axes of the four sides of the cell panel to the rail with bolts and nuts between the rails constructing the solar cell panel and by configuring a hydraulic or electric connection means between the central part between the remaining two axes and the central part between the rails.

Furthermore, large-scale eco-friendly power plants that can replace thermal power plants or nuclear power plants can be constructed with a hybrid power generation system that mutually complements solar cell panel power generation and wind power generation by configuring to share the access paths, transmission route and ESS system based on the additional configuration of a plurality of wind power generation facilities in association with vast tidal flats, wasteland or farmland.

As described above, the present invention cannot be applied in a variety of ways, produces power at the scale of a thermal power plant or nuclear power plant by utilizing neglected tidal flats, wetlands, wasteland or farmland, provides a system that is easy to install and dismantle for each solar cell panel while changing the inclination of the panel and arbitrarily varying the inclination in the 360-degree direction, and provides a method and system technology that can build a super-scale eco-friendly power plant that can replace nuclear power plants or thermal power plants in the future by improving the lifespan of the solar power generation system semi-permanently thanks to its easiness in maintaining and replacing each solar panel.

Accordingly, because the present invention can be used in various other forms without departing from the technical spirit or main characteristics of the present invention, all modifications and amendments that fall within the scope of equivalents of the claims of the present invention belong to the scope of the present invention.

### INDUSTRIAL APPLICABILITY AND USABILITY

The present invention enables building a complex solar and wind power generation facility that can replace a nuclear power plant without damaging tidal flats or farmland in abandoned tidal flats, wasteland or farmland; hence, the present invention enables constructing a hybrid power generation system that mutually complements even if there is no sunlight or no wind, thereby allowing it to be used in the construction industry of eco-friendly power plants that can replace nuclear or thermal power plants in the future.

Because the present invention's system can be installed in a river, reservoir or lake, it provides a technology that can be utilized in diverse ways in the eco-friendly power generation industry.

Also, in the present invention, the technology of constructing a solar cell panel using the rails and varying the inclination in the direction of 360 degrees to improve the solar light collection efficiency notwithstanding the position of the solar cell panel can be utilized as an effective solution to build a solar power generation system using a rooftop of a factory or shopping mall or a parking lot.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for constructing a solar cell farm on foreshore, wasteland and farmland comprising the steps of: (1) installing a plurality of reinforced concrete piles at a height of 1 m or more on a latticed divided surface of a ground or a water level of the foreshore in a solar cell panel installation area; (2) constructing a lattice-type truss by connecting a plurality of steel beams in a transverse direction on the concrete piles and a plurality of rails on the steel beams in a longitudinal direction on the steel beams; (3) installing a solar cell panel by varying the slope of the panel in 360 degrees by varying the length of a length-variable connection means between the plurality of rails of the truss and 4 axes of the left, right, upper and lower sides of the solar cell panel; (4) constructing a rail for driving the track vehicle between the rails mounted on the transverse steel beams of the truss; and thereby providing a safe structure for typhoons by lattice-type truss structure in which a load is distributed by a plurality of concrete piles, and lengthen the life of the system by easy installation, replace and maintenance of the solar cell panel using the track vehicle on the rails.

2. The method of claim 1, wherein a plurality of solar cell panel frames are connected to upper and lower portions of a solar cell panel frame to pull the solar cell panel between the rails by an electric wrench.

3. The method of claim 1, wherein the length-variable connection means is configured to be hydraulically or electrically and an ID and an electronic control device are installed to remotely control the length adjustment of each connection means.

4. The method of claim 1, wherein the concrete pile is selectively configured from a reinforced concrete pile, a PHC pile, a monopile, a steel structure pile, and a wooden structure pile.

5. The method of claim 1, wherein the transverse steel beam is configured a means selected from a steel structure, a reinforced concrete beam, and the longitudinal rail are selectively configured from T-shaped steel, L-shaped steel, H-shaped steel, stainless steel, and two or more beams combined.

6. The method of claim 1, wherein a plurality of perforated holes are formed in the rail or attached other rails having a plurality of perforated holes for bolt fastening, for fastening the length-variable connection means to the rail.

7. The method of claim 1, further constructing a facility selected from a greenhouse, a livestock shed, a warehouse, a factory, an ESS, and a solar farm management facility under the truss by constructing the concrete piles at a height of 3 m or more in farmland or wasteland.

8. The method of claim 1, wherein concrete piles on the foreshore are installed at a height of 3 m or more from the water surface of the foreshore and a passage is formed in the lower part of the truss to enable a small fishing boat to be hung on the lower part of the truss.

9. The method of claim 1, wherein stairs are configured to enter and exit the foreshore and the farmland.

10. The method of claim 1, wherein a plurality of wind power generation facilities are configured to share an access path, a transmission path, and an ESS system for building a hybrid power generation system for generating electricity even when there is no sunlight or wind.

11. The method of claim 1, wherein a reflection means selected from a mirror film and a solar cell film is formed on the rear surface of the solar cell panel so as to increase the amount of sunlight irradiated to the foreshore or farmland.
